(19) United States
(12) Patent Application Publication
(10) Pub. No.: US 2013/0137144 A1
(43) Pub. Date: May 30, 2013

(54) THERMAL BLOCK WITH BUILT-IN THERMOELECTRIC ELEMENTS

(71) Applicants: Daniel Chu, Hercules, CA (US); Paul Patt, Walnut Creek, CA (US)

(72) Inventors: Daniel Chu, Hercules, CA (US); Paul Patt, Walnut Creek, CA (US)

(73) Assignee: Bio-Rad Laboratories, Inc. LSG - GXD Division, Hercules, CA (US)

(21) Appl. No.: 13/487,414

(22) Filed: Jun. 4, 2012

Related U.S. Application Data
(60) Provisional application No. 61/494,742, filed on Jun. 8, 2011.

(51) Int. Cl. B01L 7/00

(52) U.S. Cl. CPC B01L 7/52
USPC 435/91.2; 435/303.1

(57) ABSTRACT

Rapid and uniform temperature changes in the wells of a microplate or any thin-walled plate that contains an array of reaction wells, or in the channels of a multi-channel microfluidics device, are achieved by the use of a thermal block with thermoelectric heating/cooling elements built into the block, or by the use of a thermal block with wedges protruding from its lower surface, with thermoelectric elements placed in surface contact with the angled sides of each wedge.

### CROSS-REFERENCE TO RELATED APPLICATION

This application claims the benefit of U.S. Provisional Patent Application No. 61/494,742, filed Jun. 8, 2011, the contents of which are incorporated herein by reference in their entirety.

### BACKGROUND OF THE INVENTION

1. Field of the Invention

This invention relates to sequential chemical reactions of which the polymerase chain reaction (PCR) is one example. In particular, this invention addresses methods and apparatus for performing chemical reactions simultaneously in a multitude of reaction mixtures while closely controlling the temperature in each mixture.

2. Description of the Prior Art

PCR is one of many examples of chemical processes that require a high level of temperature control of reaction mixtures with rapid temperature changes between different stages of the procedure. PCR itself is a process for amplifying DNA, i.e., producing multiple copies of a DNA sequence from a single strand bearing the sequence. PCR is typically performed in instruments that provide reagent transfer, temperature control, and optical detection of the product in a multitude of reaction vessels such as wells, tubes, or capillaries. The process includes a sequence of stages that are temperature-sensitive, different stages being performed at different temperatures and the temperature sequence being repeated in successive cycles.

While PCR can be performed in any reaction vessel, multi-well reaction plates, multi-channel microfluidics devices, and similar structures in which the process is performed concurrently in a multitude of samples, are the reaction vessels of choice. Each sample receptacle, whether it be a well of a multi-well plate or a channel of a multi-channel microfluidics device, will retain a separate sample, and all samples are simultaneously equilibrated to a common thermal environment at each stage of the process.

A 96-well plate, for example, can be used in high-throughput PCR by placing a sample in each well and placing the plate in contact with a metal block, commonly referred to as a “thermal block,” and heating and cooling the metal block according to an established protocol, either by a Peltier (thermoelectric) heating/cooling element or by a closed-loop liquid heating/cooling system that circulates a heat transfer fluid through channels machined into the block. While Peltier elements are widely described for this use, the efficiency of a Peltier element can be improved by increasing the heat transfer between the element and the thermal block and by reducing the heat load on the element.

### SUMMARY OF THE INVENTION

The present invention resides in a thermal block with one or more Peltier elements built into the block. The terms “Peltier element” and “thermoelectric heating/cooling element” are used herein interchangeably. As is well known among those familiar with these elements, they operate as heating or cooling elements depending on the direction of electric current passing through them. With Peltier elements built into the thermal block, the resulting construction has fewer thermal interfaces than conventional arrangements where the Peltier elements and the thermal block are separate components that must be joined together for use. Where the conventional Peltier element is a laminated structure whose outer layers are ceramic materials that are thermally conducting, the thermal block of the present invention utilizes the metal piece of conventional thermal blocks as the outer layer on the side of the Peltier element that faces the reaction plate. The layers that form the thermal block, from the top down, are therefore (i) a metal piece whose upper surface is contoured to match the contour of the underside of the reaction plate, and thereby to provide maximal contact with each sample receptacle of the sample plate when the plate is lowered onto the metal piece, (ii) a thin layer of an electrically insulating material on the lower surface of the metal piece, (iii) the electrically conductive strips that join together the P-doped and N-doped semiconductor blocks that are the operative components of the Peltier element; (iv) the semiconductor blocks themselves; (v) electrically conductive strips at the bottoms of the semiconductor blocks, and (vi) a heat sink. An optional additional layer included in certain embodiments of the invention is an electrically insulating layer between the lower layer of electrically conductive strips, and the heat sink. The electrically conductive strips referred to above as layer (v) are thermally coupled to the heat sink, the term “thermally coupled” being used herein to denote that heat readily passes from the electrically conductive strips to the heat sink and vice versa, either directly or through the electrically insulating layer when the latter is present. In certain embodiments of the invention, layers (ii), (iii), (iv), and (v) and the heat sink form a single piece permanently joined together that is then joinable to the metal block by removable attaching means such as screw fasteners, clamps, or the like. In other embodiments, all six layers are permanently joined together as a single piece. Conventional permanent joining means such as an adhesive can be used in these latter embodiments.

These and other embodiments, objects and advantages of the invention will be apparent from the attached drawings and the description that follows.

### BRIEF DESCRIPTION OF THE DRAWINGS

FIG. 1 is a cross section view of a portion of one example of a thermal block of the present invention in combination with a reaction plate.

FIG. 2 is a cross section view of a portion of another example of a thermal block of the present invention in combination with a reaction plate.

FIG. 3 is a perspective view of a microfluidics device serving as the reaction plate in combination with still another example of a thermal block of the present invention.

FIG. 4 is a cross section view of the microfluidics device and thermal block of FIG. 3.

### DETAILED DESCRIPTION OF THE INVENTION AND SELECTED EMBODIMENTS

As noted above, the term “sample plate” is used herein to denote any device or component that holds samples (reaction mixtures) in individual locations where they can individually undergo chemical reactions without being influenced by or interfering with the reactions occurring in samples at other locations in the plate. While detailed attention is directed herein to multi-well plates and microfluidics devices as examples of sample plates, other examples will be apparent to those of skill in the performance of chemical reactions simultaneously in a multitude of small reaction mixtures. For sample plates that are multi-well plates, the plates will often be of a thin material that heat readily passes through, and the wells will be arranged in a geometrical, often rectangular, array, with adjacent connected by a deck portion of the plate, which in many cases is a continuous flat portion that is joined to the wells at their rims. The deck portion can also consists of filaments joining the wells, or any such structure that holds the wells in fixed positions. The wells themselves will typically extend below the deck portion, with convex undersurfaces that are exposed for direct contact with the thermal block. By “convex” is meant that the undersurfaces are the outer surfaces of the wells, surrounding the well interiors. For rectangular wells, for example, the convex undersurfaces will be the outersurfaces of a rectangular block; for conical or cylindrical wells, the convex undersurfaces will be conical or cylindrical in shape, and for wells with parabolic or hemispherical profiles, the convex surfaces will likewise have parabolic or hemispherical profiles. For sample plates that are microfluidics devices, the channels will generally be cut or etched in the body of the device and may not have undersides that extend below a deck. The undersides of the channels and hence of the device itself may therefore be flat. The device walls will often be thin enough however that rapid heat transfer in and out of each channel is still readily achieved.

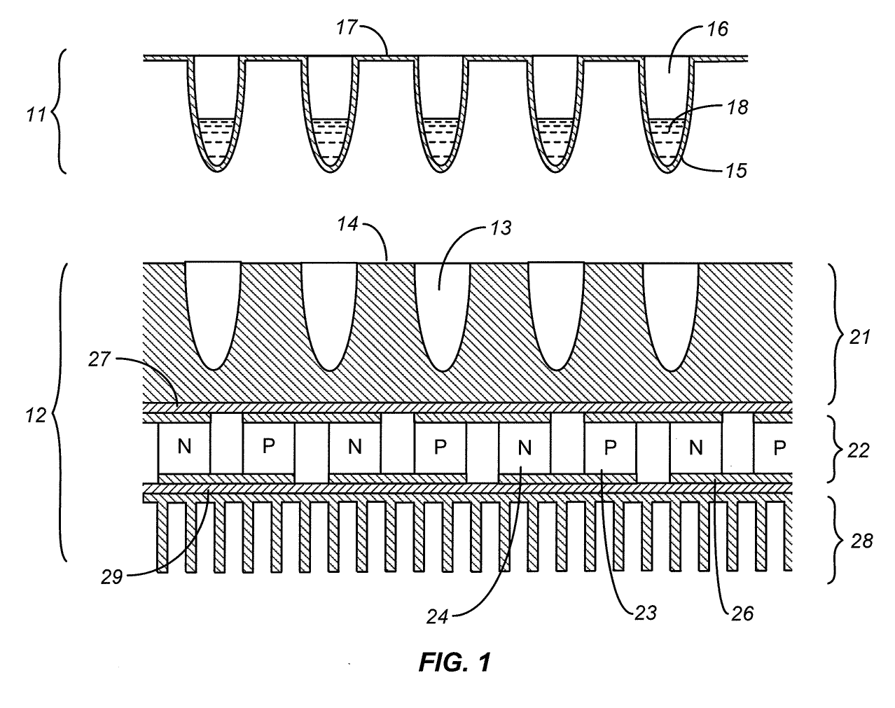

In FIG. 1, a reaction or sample plate 11 (the terms “reaction plate” and “sample plate” are used herein interchangeably) is shown raised above a thermal block 12 of the present invention, both shown in cross section. As in many sample plates and thermal blocks of the prior art, the indentations 13 in the upper surface 14 of the thermal block have a curved or tapered contour that matches the undersides 15 of the individual wells 16 of the sample plate so that when the plate 11 is lowered onto the block 12, there is continuous surface contact between the block and each well of the plate. While the structures shown provide full continuous contact including contact along the deck portion, shown here as webs 17 that connect the wells, proper thermal control of the liquid reaction mixtures 18 in each well can also be achieved if the surface contact between the plate and the thermal block is limited to the walls of the wells rather than the entire plate. Although not shown, a sealing film or cap is often used to cover the tops of the wells 16, and a heater plate is often placed above the sample plate 11 and pressed down over the sample plate to make contact between the sample plate and the thermal block 12. In these cases, the indentations 13 in the thermal block are shallow relative to the wells 16 of the sample plate, thereby leaving a gap between the webs 17 and the thermal block 12. This gap allows the temperature of the heater plate, which is typically 90-110° C., to be maintained independently of the temperature of the thermal block 12.

The upper layer 21 of the block 12 is the metal piece that transmits heat to and from the wells by virtue of its direct contact with the wells and its high thermal conductivity. The thermoelectric element 22 is constructed of conventional components, central to which are the P-doped and N-doped semiconductor blocks 23, 24 and the electrically conductive strips 25, 26 joining the blocks in alternating manner according to conventional Peltier element construction. Between the Peltier element 22 and the metal piece 21 is a layer of electrically insulating material 27, and between the Peltier element 22 and the heat sink 28 is a second layer of electrically insulating material 29. The semiconductor blocks 23, 24 can be of conventional construction and materials. The selection of particular materials of construction may vary with the operating conditions for the reactions that will occur within the wells and the temperature range that the reaction mixtures will be cycled through. An example of a semiconductor material useful for this purpose is bismuth telluride doped with either bismuth selenide (for N-doping) or antimony telluride (for P-doping). With one P-doped block and one N-doped block defined as a couple, four couples are shown, but the number of couples can be as few as one or as many as several hundred. The number is not critical and will vary with the dimensions of the thermal block and the sample plate, although in most cases the number will be no greater than one hundred. The electrically conductive strips 25, 26 can be copper or any other conventional electric lead material. Examples of materials that can be used for the layers of electrically insulating material 27, 29 are ceramics, notably aluminum oxide or beryllium oxide. Alternatively, a thin polyimide sheet can be used. The thicknesses of these layers can vary but will generally be selected to be thick enough to provide both electrical insulation and structural integrity or support, yet thin enough to transmit heat. Additional layers for optional inclusion, although not shown in this Figure, are coatings on the surfaces of the semiconductor blocks to serve as diffusion barriers, for example, or to facilitate the joining of the surfaces to the conductive leads. Shear films can also be included to allow movement, and thereby reduce shear stress, at the interfaces between the semiconductor materials, the thermal block, and the sample plate, such stress often resulting from expansion and contraction of these elements due to temperature changes. These and other optional variations will be readily apparent to those skilled in the use of Peltier elements and familiar with the literature on Peltier elements.

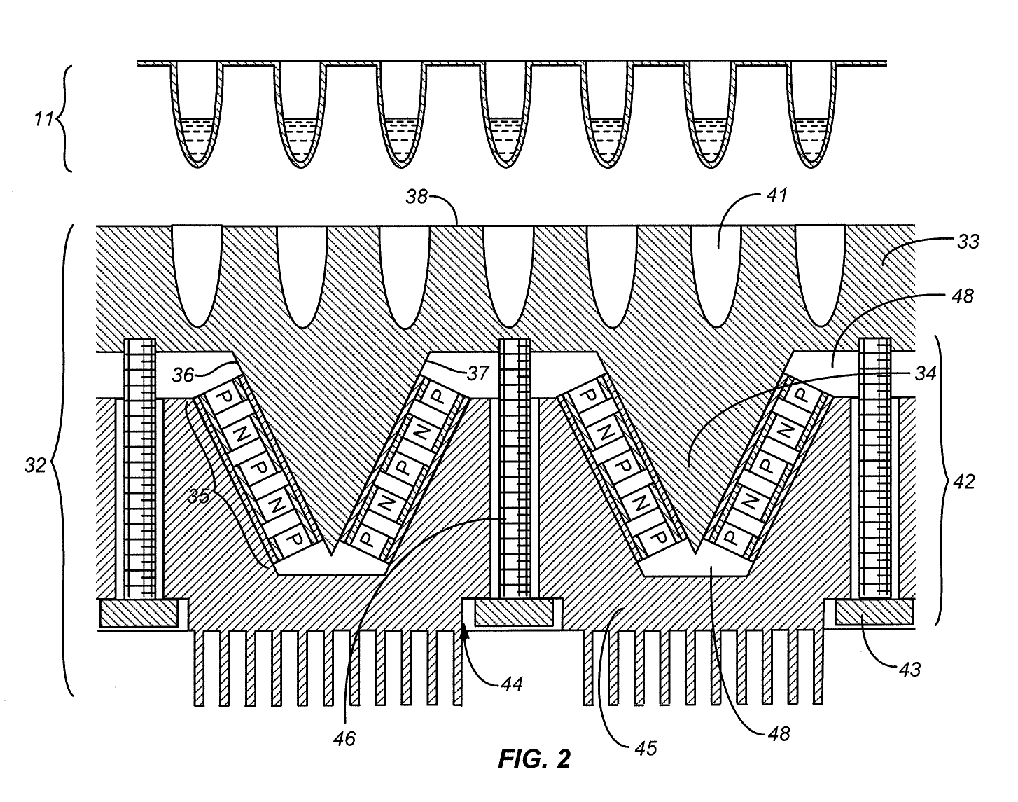

The FIG. 2, a sample plate 11 is poised above an alternative thermal block 32 of the present invention. The metal piece 33 of this thermal block contains wedge-shaped projections 34 extending downward from the underside of the piece to provide increased contact area for the Peltier elements 35. Each wedge has angled sides 36, 37 that form acute angles with the upper surface 38 of the metal piece 33. Thus, for a unit lateral width of the thermal block 32, a greater number of Peltier elements 35 can be incorporated by virtue of the presence of the wedges 34.

The construction and composition of the individual Peltier elements can be the same as those of the embodiment of FIG. 1. The angle of each wedge 34, the spacing between adjacent wedges, the locations of the wedges relative to the locations of the indentations 41 in the top of the metal piece, and the length of each wedge can all vary, and the choices for optimal performance in any given thermal block will depend primarily on economic considerations of the ease and cost of fabrication of the thermal block, together with any spatial constraints on the thermal block, particularly when the thermal block is to be used in an instrument that contains additional components. All such choices and variations will be readily apparent to those skilled in the art, and if necessary, readily determinable by routine experimentation.

Another distinguishing feature of the embodiment of FIG. 2 is the two-piece construction of the thermal block. The metal piece 33 in this construction is separate or separable from the remaining components, and the two are held together by screws 42. The head 43 of each screw resides in a recess 44 in the underside of the heat sink 45, the shaft 46 of each screw passes through a hole in the heat sink, and the tip 47 of each screw threads into a threaded hole in the metal piece 33. When joined as show, the two pieces leave gaps 48 between them at certain locations, the gaps typically occupied by air.

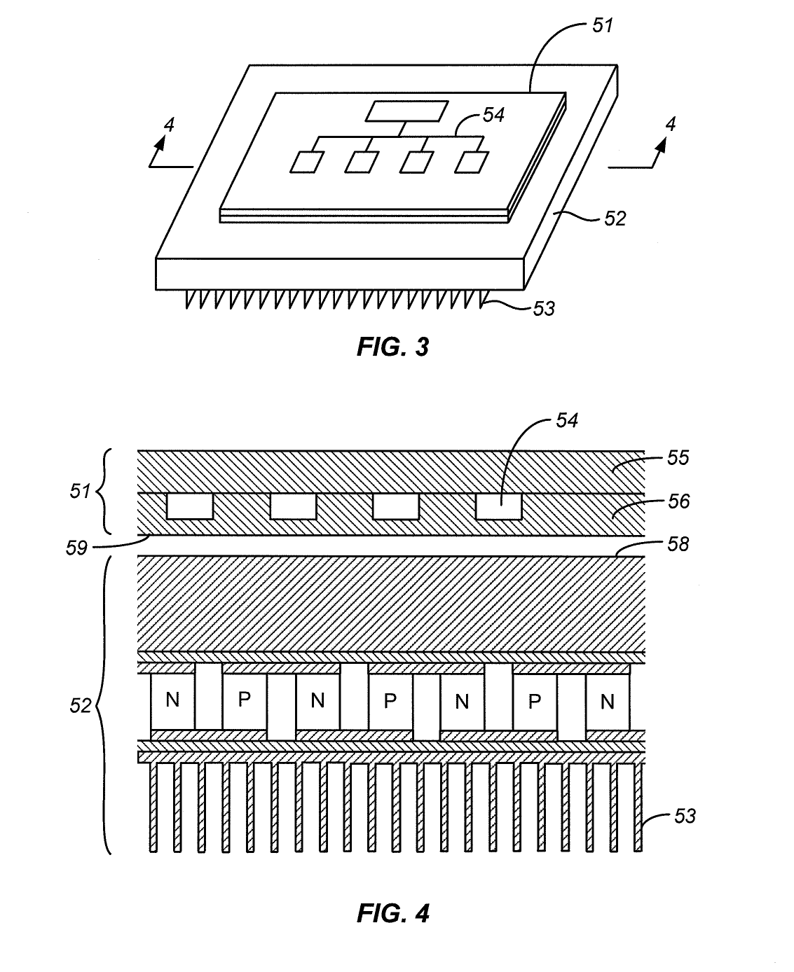

FIGS. 3 and 4 illustrate the application of the present invention to a microfluidics device. FIG. 3 is a perspective view of the microfluidics device 51 resting on the surface of a thermal block 52. Of the thermal block 52, only the outer surfaces and portions of the fins 53 that serve as a heat sink are visible. Of the microfluidics device 51, the channels are all internal to the device, but their locations are indicated by the lines 54 on the upper surface of the device.

FIG. 4 is a vertical cross section of the microfluidics device 51 and thermal block 52 of FIG. 3 taken along the line 4-4 of FIG. 3, with the microfluidics device poised above the thermal block for ease of viewing. The microfluidics device 51 is shown as a laminated structure with two laminae 55, 56 bonded or fused together, the microchannels 54 being etched into the lower lamina 57 and closed at the top by the upper lamina 56. The thermal block 52 is identical to the thermal block 12 of FIG. 1 except that its upper surface 58 is flat to complement the lower surface 59 of the microfluidics device. In use, the two surfaces will be in full contact. In an alternative construction, a thermal block identical to that of the thermal block 32 of FIG. 2 can be used, provided that it has an upper surface that is flat like that of the thermal block 52 of FIG. 4.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

What is claimed is:

1. Apparatus for thermal cycling of a plurality of reaction mixtures, said apparatus comprising:
a sample plate comprising a plurality of receptacles for said reaction mixtures and an underside;
a thermal block with an upper surface that is complementary in contour to said underside of said sample plate; and
a thermoelectric heating/cooling element incorporated into said thermal block.

2. The apparatus of claim 1 comprising a plurality of thermoelectric heating/cooling elements incorporated into said thermal block.

3. The apparatus of claim 1 wherein said sample plate further comprises a deck portion joining said receptacles, said receptacles are wells with convex undersides extending downward from said deck portion, and said upper surface of said thermal block is complementary in contour to said convex undersides of said wells.

4. The apparatus of claim 1 wherein said sample plate is a microfluidics device, and said receptacles are microchannels in said microfluidics device.

5. The apparatus of claim 1 wherein said thermal block comprises:
(i) a metallic layer having an upper surface constituting said upper surface of said thermal block;
(ii) a layer of electrically insulating material bonded to a lower surface of said metallic layer; and
(iii) a thermoelectric heating/cooling element bonded to said layer of electrically insulating material, said thermoelectric heating/cooling element comprising:
(a) upper electrically conductive strips joining upper sides of P-doped and N-doped semiconductor blocks and bonded to said layer of electrically insulating material, and
(b) lower electrically conductive strips joining lower sides of said P-doped and N-doped semiconductor blocks and thermally coupled to a heat sink.

6. The apparatus of claim 5 further comprising an electrically insulating layer between said lower electrically conductive strips and said heat sink.

7. The apparatus of claim 1 wherein said thermal block further comprises a lower surface shaped to form a wedge extending downward with angled sides forming acute angles relative to said upper surface, and wherein said thermoelectric heating/cooling element is bonded to each of said angled sides.

8. The apparatus of claim 7 wherein said lower surface of said thermal block is shaped to form a plurality of said wedges and said apparatus comprises a plurality of thermoelectric heating/cooling elements, with at least one of said thermoelectric heating/cooling elements bonded to each angled side of each of said wedges.

9. The apparatus of claim 7 wherein said sample plate further comprises a deck portion joining said receptacles, said receptacles are wells with convex undersides extending downward from said deck portion, and said upper surface of said thermal block is complementary in contour to said convex undersides of said wells.

10. The apparatus of claim 7 wherein each said thermal block comprises:
(i) a metallic layer having an upper surface that forms said upper surface of said thermal block;
(ii) a layer of electrically insulating material bonded to an angled side of one of wedges; and
(iii) a thermoelectric heating/cooling element bonded to said layer of electrically insulating material, said thermoelectric heating/cooling element comprising:
(a) upper electrically conductive strips joining upper sides of P-doped and N-doped semiconductor blocks and bonded to said layer of electrically insulating material, and
(b) lower electrically conductive strips joining lower sides of said P-doped and N-doped semiconductor blocks and thermally coupled to a heat sink.

11. The apparatus of claim 10 further comprising an electrically insulating layer between said lower electrically conductive strips and said heat sink.

12. A method for heating and cooling a plurality of reaction mixtures through a prescribed heating and cooling cycle, said method comprising:
(a) placing said reaction mixtures in individual receptacles of a sample plate comprising a plurality of receptacles;
(b) placing said sample plate in contact with a thermal block that comprises:
(i) an upper surface that is complementary in contour to the underside of said sample plate and
(ii) a thermoelectric heating/cooling element incorporated into said thermal block; and
(c) activating said thermoelectric heating/cooling element in accordance with said prescribed heating and cooling cycle to thereby heat and cool said plurality of reaction mixtures.

13. The method of claim 12 wherein said sample plate further comprises a deck portion joining said receptacles, said receptacles are wells with convex undersides extending downward from said deck portion, and said upper surface of said thermal block is complementary in contour to said convex undersides of said wells.

14. The method of claim 12 wherein said sample plate is a microfluidics device, and said receptacles are microchannels in said microfluidics device.

15. The method of claim 12 wherein said thermal block comprises:
(i) a metallic layer having an upper surface that forms said upper surface of said thermal block;
(ii) a layer of electrically insulating material bonded to a lower surface of said metallic layer; and
(iii) a thermoelectric heating/cooling element bonded to said layer of electrically insulating material, said thermoelectric heating/cooling element comprising:
(a) upper electrically conductive strips joining upper sides of P-doped and N-doped semiconductor blocks and bonded to said layer of electrically insulating material, and
(b) lower electrically conductive strips joining lower sides of said P-doped and N-doped semiconductor blocks and thermally coupled to a heat sink.

16. The method of claim 15 wherein said thermoelectric heating/cooling element further comprises an electrically insulating layer between said lower electrically conductive strips and said heat sink.
